(19) United States
(12) Patent Application Publication
(10) Pub. No.: US 2014/0277614 A1
(43) Pub. Date: Sep. 18, 2014

(54) PROGRAMMABLE USER INTERFACE FOR A MACHINE

(71) Applicant: CATERPILLAR INC., Peoria, IL (US)

(72) Inventor: David C. Larimer, Peoria, IL (US)

(73) Assignee: Caterpillar Inc., Peoria, IL (US)

(21) Appl. No.: 13/836,012

(22) Filed: Mar. 15, 2013

(51) Int. Cl. G05B 19/04

(52) U.S. Cl. CPC G05B 19/0405
USPC 700/83

(57) ABSTRACT

An operator station for a machine is provided. The operator station includes a display device, an operator input device and a programmable user interface. The programmable user interface is configured to provide an array of feedback options. Further, the programmable user interface is configured to receive an input indicative of a selected customized feedback option from the array of feedback options. Furthermore, the programmable user interface is configured to provide a feedback associated with an operational state of the machine on at least one of the display device and the operational input device. The feedback associated with the operational state of the machine is based on the selected customized feedback option.

### TECHNICAL FIELD

The present disclosure relates to a programmable user interface for a machine, and more particularly to a programmable user interface for providing feedback associated with the machine.

### BACKGROUND

Generally, machines are controlled using a number of input devices, such as joysticks, pedals, steering wheels, etc. Input signals from theses input devices are sent to an engine control module (ECM) of a machine, which further controls operation of a number of actuators to control operational states of an implement system of the machine. The actuators are further controlled by actuator valves. These valves and actuators do not provide any feedback to an operator within the machine, as these valves and the actuators are electrically coupled to the ECM.

For example, U.S. Pat. No. 6,070,539 relates to a variable rate agricultural product application implement for dispensing agricultural products, such as seed, fertilizer, herbicide and pesticide. The agricultural product may be dispensed at each of a plurality of row locations on an agricultural implement toolbar. A local bus connects each local metering device to a local controller at the row location. The local controllers are connected through a system bus to a central processor mounted on the tractor.

### SUMMARY OF THE DISCLOSURE

In one aspect of the present disclosure, an operator station for a machine is provided. The operator station includes a display device, an operator input device and a programmable user interface. The programmable user interface is configured to provide an array of feedback options. Further, the programmable user interface is configured to receive an input indicative of a selected customized feedback option from the array of feedback options. Furthermore, the programmable user interface is configured to provide a feedback associated with an operational state of the machine on the display device and the operational input device. The feedback associated with the operational state of the machine is based on the selected customized feedback option.

In another aspect of the present disclosure, a programmable user interface within an operator station of a machine is provided. The programmable user interface is configured to provide an array of feedback options. Further, the programmable user interface is configured to receive an input indicative of a selected customized feedback option from the array of feedback options. Furthermore, the programmable user interface is configured to provide a feedback associated with an operational state of the machine on a display device and an operational input device. The feedback associated with the operational state of the machine is based on the selected customized feedback option.

In a yet another aspect of the present disclosure, a method for providing feedback associated with an operational state of a machine is provided. The method provides an array of feedback options using a programmable user interface. The method further receives an input indicative of a selected customized feedback option from the array of feedback options. Furthermore, the method provides a feedback associated with an operational state of the machine on a display device and an operational input device. The feedback associated with the operational state of the machine is based on the selected customized feedback option

Other features and aspects of this disclosure will be apparent from the following description and the accompanying drawings.

### BRIEF DESCRIPTION OF THE DRAWINGS

FIG. 1 illustrates a perspective view of an exemplary machine;

FIG. 2 illustrates an exemplary electro-hydraulic control system for the machine, according to an embodiment of the present disclosure;

FIG. 3 illustrates a perspective view of an operator station of FIG. 1; and

FIG. 4 illustrates an exemplary method of providing feedback associated with an operational state of the machine.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts.

The present disclosure relates to a programmable user interface for providing feedback associated with an operational state of a machine. FIG. 1 illustrates a perspective view of an exemplary machine 100, such as a hydraulic excavator, in which various embodiments of the present disclosure may be implemented. Although, in the illustrated embodiment, the machine 100 is embodied as the hydraulic excavator, in various other embodiments, the machine 100 may be, but not limited to, an off-highway truck, on-highway truck, a backhoe loader, an industrial loader, a skidder, a wheel tractor, an excavator, a wheel dozer, an articulated truck, a asphalt paver, a cold planer, a compactor, a motor grader, a hydraulic shovel, or the like. The machine 100 may be a fixed or mobile machine that performs operations associated with an industry such as mining, construction, farming, or any other industry known in the art.

The machine 100 may include an implement system 102 configured to move an implement 104, a drive system 106 for propelling the machine 100, a power source 108 that provides power to the implement system 102, the drive system 106, and an operator station 110 to control the implement system 102 and the drive systems 106. As illustrated in FIG. 1, the implement system 102 may include a boom member 112 pivotally connected to a frame 114 of the machine 100 and configured to vertically pivot about a first horizontal axis (not shown) relative to a ground 116 by a pair of double-acting, first hydraulic actuators 118 (only one side shown in FIG. 1). The implement system 102 may also include a stick member 120 pivotally connected to the boom member 112 and configured to vertically pivot about a second horizontal axis 122 by a double-acting, second hydraulic actuator 124. Further, the implement 104 is pivotally connected to the stick member 120 and configured to vertically pivot about a third horizontal axis 126 by a double-acting, third hydraulic actuator 128. In another implementation, the actuators 118, 124 and 128 may be pneumatic type actuators.

The drive system 106 may include one or more traction devices to propel the machine 100. In an embodiment, the drive system 106 may include a left side track 130 located on one side of the machine 100, and a right side track 132 located on another side of the machine 100. The left side track 130 may be driven by a left travel motor 134, while the right side track 132 may be driven by a right travel motor 136. The left and the right travel motors 134, 136 may be low speed, high torque type hydraulic motors of any other well-known construction, such as an axial piston motor, a radial piston motor, or a vane type motor. Alternatively, the drive system 106 may include other type of traction devices such as wheels, belts, or other known traction devices.

The power source 108 may embody an engine such as a diesel engine, a gasoline engine, a gaseous fuel-powered engine, or any other type of combustion engine known in the art. It is contemplated that the power source 108 may alternatively embody a non-combustion source of power such as a fuel cell, a power storage device, or another source known in the art. The power source 108 may produce a mechanical or electrical power output that may be used to pressurize a hydraulic fluid for moving the hydraulic actuators 118, 124, 128 and the left and the right travel motors 134, 136.

The operator station 110 includes one or more operator input devices 138 configured to receive or transmit various inputs, from an operator, indicative of a desired movement of the implement 104 and/or the machine 100. The operator input devices 138, which may be embodied as joysticks. However, it is contemplated that different type of the operator input devices 138 may alternatively or additionally be included within the operator station 110 such as, for example, steering wheel, knobs, push-pull devices, switches, pedals, touch screens, displays and any other operator input devices known in the art. Although, the operator station 110 is depicted to be on the machine 100, it will be understood that the operator station 110 may in other embodiments, be located remotely for controlling the machine 100 in an autonomous mode.

FIG. 2 illustrates an exemplary electro-hydraulic control system 140 for the machine 100. The electro-hydraulic control system 140 (hereinafter referred to as the control system 140) may be configured to control an operational state of the machine 100 and/or the implements system 102 in response to an input received from the operator input devices 138. For example, the control system 140 may be configured to control the movement of the hydraulic actuators 118, 124 and 128 which in turn operate the boom member 112, the stick member 120 and the implement 104, respectively. The control system 140 may include one or more control valves, for example a boom control valve 148, a stick control valve 150, and an implement control valve 152 to selectively control a flow of pressurized fluid from a pump (not shown) to the hydraulic actuators 118, 124 and 128 respectively. In an embodiment, the control system 140 may also include a travel control valve to selectively control a flow of pressurized fluid from the pump to the left and the right travel motors 134, 136. Although, the control system 140 depicts only three control valves 148, 150, and 152, it will be understood that the number is merely exemplary and may be varied based on the application and type of machine, to achieve similar results.

A machine engine control module (ECM) 142 may be provided to receive inputs indicative of a detected movement of the operator input devices 138 to control an operational state of the implement system 102 and/or the machine 100. A sensor 141 may send the inputs indicative of the desired operational state of the implement system 102 and/or the machine 100 from the operational input devices 138 to the machine ECM 142. Based on the desired operational state input, the machine ECM 142 may generate one or more commands for a valve ECM 144 to control flow of pressurized fluid to the hydraulic actuators 118, 124 and 128 using the control valves 148, 150 and 152. In an embodiment, the control valves 148, 150 and 152 may be solenoid operated position control valve. In an alternate embodiment, the control valves 148, 150 and 152 may be hydraulically or pneumatically operated valves.

The machine ECM 142 may communicate with the valve ECM 144 and the operator input devices 138 using any appropriate communication mechanism. In one embodiment, the machine ECM 142 may communicate with the valve ECM 144 and the operator input devices 138 using a CAN bus 146. In alternate embodiments, the machine ECM 142 may communicate with the operator input devices 138 and the valve ECM 144 using serial bus communication links, proprietary communication links, direct electrical communication links and the likes. In the illustrated example, two ECMs are depicted, but any number of control modules may be used. Exemplary architectures for implementing an ECM may include general purpose processors, application specific integrated circuits, programmable logic devices and the likes.

In an embodiment, the control system 140 may include one or more sensors, such as sensors 154, 156 and 158 configured to monitor one or more parameters associated with the operating state of the implement system 102 and/or the machine 100. In one embodiment, the sensors 154, 156 and 158 may be pressure sensors to sense a pressure of fluid that is supplied to the hydraulic cylinders 118, 124 and 128 using the control valves 148, 150 and 152. In an alternate embodiment, the sensors 154, 156 and 158 may be position sensor to sense a displacement in the hydraulic cylinder 118, 124 and 128 indicative of the movement and/or position of the implement system 102. The sensors 154, 156 and 158 may be configured to send feedback signals based on the sensed pressure and/or the displacement, to the machine ECM 142 via the valve ECM 144.

According to an embodiment of the present disclosure, the operator station 110 includes a programmable user interface 160 configured to provide an array of feedback options 162 (hereinafter referred to as the array 162) to an operator. The programmable user interface 160 may be configured to operatively communicate with the machine ECM 142 and receive feedback signals indicative of the fluid pressure and/or the movement of the implement system 102 as monitored by the sensors 154, 156 and 158. In an exemplary embodiment, the programmable user interface 160 may utilize the valve ECM 144 to monitor the pressure of fluid that is supplied to the hydraulic cylinders 118, 124 and 128 for controlling the operational state of the machine 100 and/or the implement system 102. Further, the machine ECM 142 may be configured to send feedback signals to the programmable user interface 160 based on the feedback signals received from the sensors 154, 156, and 158 via the valve ECM 144.

According to an embodiment of the present disclosure, the array 162 may include a tactile feedback 168 configured to be provided on the operator input devices 138, an audio feedback 170 configured to be provided on an audio device 164 and a visual feedback 172 configured to be provided on a display device 166 within the operator station 110. Examples of the audio devices 164 may include one or more loud speakers within the operator station 110, headphones or earphones that may be connected using a port to the programmable user interface 160, and the likes. Examples of the display devices 166 may include a monitor such as a liquid crystal display (LCD), a light emitting diode (LED) display, a thin film transistor (TFT) display, or a cathode ray tube (CRT) display. The display device 166 may also include a touchscreen display panel to enable the operator to input or select the desired feedback option from the array 162.

In an embodiment, the operator input devices 138 may include variants of electro-mechanical haptic technology based devices 167 such as joystick shaker, or other touch sensitive output devices. The machine ECM 142 may be operatively connected to the haptic technology based devices 167 of the operator input devices 138 to provide the tactile feedback based on the feedback signals from the sensors 154, 156, and 158. For example, the machine ECM 142 may activate the haptic technology based device 167 to provide the tactile feedback on the operator input device 138.

As illustrated in the figure, the audio devices 164 may include one or more signal receptor members (not shown). The machine ECM 142 may be operatively connected to the signal receptor member to provide the audio feedback on the audio devices 164 based on the feedback signals from the sensors 154, 156, and 158. Further, the machine ECM 142 may be operatively coupled to the display device 166 to provide the visual feedback based on the feedback signals from the sensors 154, 156, and 158.

According to an embodiment of the present disclosure, the array 162 may be operator customizable. In an embodiment, the array 162 may include operator selectable tabs for each type of feedback option, such as a tab for tactile feedback 168, a tab for the audio feedback 170 and a tab for the visual feedback 172, as shown in the figure. The operator may activate any one or combination of the feedback options by activating the corresponding tabs on the array of feedback options 162.

In an embodiment of the present disclosure, the programmable user interface 160 may be configured to receive an input indicative of a selected customized feedback option from the array 162. Furthermore, the programmable user interface 160 may be configured to provide the feedback associated with the operational state of the machine 100 and/or the implement system 102 to the operator. For example, on activation of the tab for tactile feedback 168, the programmable user interface 160 may be configured to communicate with and send a signal indicative of operator selected tactile feedback option to the machine ECM 142. In response, the machine ECM 142 activates the haptic technology based device 168 of the operator input device 138 to provide the tactile feedback based on the feedback signals from the sensors 154, 156 and 158. Therefore, based on the pressure supplied to the control valves 148, 150 and 152, a proportionate tactile load may be experienced on the operator input devices 138.

In an aspect of the present disclosure, the operator may further customize the tactile feedback 168 in the array 162. In one embodiment, the programmable user interface 160 may include additional programmable tabs for customizing the feedback options. For example, the operator may select to receive a low intensity tactile feedback on the operator input devices 138, based on a low pressure detected by the sensors 154, 156 and 158. Similarly, the operator may select to receive a high intensity tactile feedback on the operator input devices 138, based on a high pressure detected by the sensors 154, 156 and 158. The operator may also select any one of the operator input devices 138, such as the joystick, steering wheel, pedals, seat etc., to receive the tactile feedback.

In an embodiment of the present disclosure, on activation of the tab for audio feedback 170 from the array 162, the programmable user interface 160 may be configured to communicate with and send a signal indicative of operator selected audio feedback option to the machine ECM 142. In response, the machine ECM 142 may be configured to send the feedback signals to the audio devices 164. The receptor member within the audio devices 164 may receive the feedback signals from the machine ECM 142 and provide an audio feedback output using the audio devices 164.

Further, the operator may customize the audio feedback 170 in the array 162 by activating one or more programmable tabs in the programmable user interface 160. For example, the operator may select to receive a voice message, or a ringtone based on the feedback signal from the sensors 154, 156 and 158. For example, if the pressure of fluid that is supplied to the hydraulic cylinders 118, 124 and 128 using the control valves 148, 150 and 152 is high, then a corresponding audio signal such as a high pitch or high volume beep sound or a voice message or a specific ringtone indicating the sensed high pressure may be provided to the operator.

The operator may further customize the audio feedback 170 by selecting adjustable volume, pitch, frequency and other parameters associated with the audio feedback 170, by activating corresponding tabs in the programmable user interface 160. For example, for a high pressure sensed by the sensors 154, 156 and 158, the operator may not want to receive a proportionately high volume audio feedback, instead the operator may select to receive a low volume ringtone or a low volume voice message for the sensed high pressure.

In an alternate embodiment, the operator station 110 may include additional input devices such as rotary switches or push buttons, etc., configured to adjust the volume, pitch, and frequency etc., associated with the audio feedback. In a still further embodiment, the operator may use a combination of the tabs on the programmable user interface 160 and the additional input devices in the operator station 110 to adjust the parameters associated with the audio feedback. The operator may further customize the audio feedback 170 for each hydraulic cylinder 118, 124 and 128 corresponding to the feedback signals from the sensors 154, 156 and 158 for the control valves 148, 150 and 152 respectively. Furthermore, the operator may also select any one of the audio devices, such as the loud speaker, or the headphones to receive the audio feedback, by activating corresponding tabs in the programmable user interface 160.

In a further embodiment of the present disclosure, on activation of the tab for visual feedback 172 in the array 162, the programmable user interface 160 may be configured to communicate with and send a signal indicative of operator selected visual feedback option to the machine ECM 142. In response, the machine ECM 142 may be configured to send the feedback signals to the display device 166 for providing a visual feedback to the operator.

In addition, the operator may customize the visual feedback 172. For example, the operator may select to view a graphical form of feedback, or an animated view of the implement system 102 on the display device 166, based on the feedback signals from the sensors 154, 156 and 158. In an embodiment, the operator may further customize the form of graphical feedback to view a bar chart or a pie chart. On activation of a tab corresponding to a bar chart, the programmable user interface 160 may be configured to provide a bar graph corresponding to the feedback signals received from the sensors 154, 156 and 158, as shown in the figure.

In one embodiment, the bar chart may indicate a proportionate rise or fall in a positive as well as in a negative direction of a bar corresponding to the sensed pressure of fluid that is supplied to the hydraulic cylinders 118, 124 and 128 using the control valves 148, 150 and 152 respectively that further control the boom member 112, the stick member 120 and the implement 104 respectively in a forward or a reverse direction. In another embodiment, the bars may indicate the proportionate displacement in the actuators 118, 124 and 128 that control the boom member 112, the stick member 120 and the implement 104 respectively in a forward or a reverse direction.

As shown in the figure, an axis X-X indicates a neutral reference point, where the implement 104, the boom member 112 and the stick member 120 are at rest or not working. Therefore, while operating, for the stick member 120, if the fluid pressure sensed at the corresponding control valve 148 is high, then a bar 202 corresponding to the stick member 120 may also rise in a positive direction to indicate sensed high pressure at the control valve 148. Whereas, the third bar 206 in the graph may indicate that the fluid pressure sensed at the corresponding control valve 152 is high for moving the implement 104 in a reverse direction. In a further embodiment of the present disclosure, the user may add other graphical representations corresponding to additional actuators and implements in case of other types of machines. Furthermore, the operator may further customize the graph to a desired format, such as a bar chart, a pie chart, or any other format of graph. In an alternate embodiment, the operator may select to view an animated view of the operational state of the implement system 102 and/or the machine 100.

In a further embodiment, the operator may select multiple forms of feedback from the array 162 to be received. For example, along with the visual feedback, the operator may select to receive audio feedback 170 and/or the tactile feedback 168 at the same time. In an embodiment of the present disclosure, the programmable user interface 160 is configured to store the selected customized feedback option. For example, the operator may save the customized feedback options and create a user profile for subsequent uses. For example, the operator may login to the programmable user interface 160 using his/her login credentials, and receive the feedback in the format as previously saved by the operator. In a further embodiment, different operators may have their respective user profiles of the desired feedback options as set by them.

FIG. 3 illustrates an exemplary perspective view of the operator station 110 of FIGS. 1 and 2, including the programmable user interface 160 according to the various aspects of the present disclosure. In an embodiment, the programmable user interface may provide the tactile feedback on one of the operator input devices 138, such as a steering wheel 138-1, the implement system control joystick 138-2, the seat 138-3, the pedals 138-4 or the like. Further, the operator station 110 may include a display device 166 to provide the visual feedback. Furthermore, the operator station 110 may include the audio devices 164, such as a loud speaker to provide audio feedback.

### INDUSTRIAL APPLICABILITY

Generally, machines are controlled using a number of input devices, such as joysticks, pedals, steering wheels, etc. Input signals from theses input devices are sent to an engine control module (ECM) of a machine, which further controls operation of a number of actuators to control operational states of an implement and/or the machine. The actuators are further controlled by control valves. These control valves and actuators do not provide any feedback to an operator within the machine, as these valves and the actuators are electrically coupled to the ECM.

The present disclosure provides the programmable user interface 160 for providing a feedback associated with an operational state of the machine 100. The programmable user interface 160 provides the customizable array of feedback options 162 that may be customized as per an operator's choice. The operator may select to receive any one or a combination of the feedback options from the array 162. The operator may select to receive a tactile feedback 168, an audio feedback 170 or the visual feedback 172 on the operator input devices 138, and/or the audio devices 164, and/or the display device 166 within the operator station 110 respectively. The operator may further customize these feedback options to customize the intensity of the tactile feedback, the volume, pitch etc., of the audio feedback, or the type of visual feedback such as graph or animated view of the machine 100 and/or the implement system 102. The feedback associated with the operational state of the machine 100 is received in the form of feedback signals from the sensors 154, 156 and 158 configured to monitor the pressure of fluid that is applied to the actuators 118, 124, and 128 using the control valves 148, 150 and 152. Thus, the operator can receive a feedback to sense the fluid status and the mechanical status of the machine 100.

FIG. 4 illustrates an exemplary method for providing a feedback associated with an operational state of the machine. Initially, at step 402, an array of feedback options 162 is provided using the programmable user interface 160. In one embodiment, the array 162 may be customizable. For example, the array 162 may include the tactile feedback 168, the audio feedback 170 and the visual feedback 172. The tactile feedback 168, the audio feedback 170 and the visual feedback 172 may be further customizable.

At step 404, an input indicative of a selected customized feedback option from the array is received. In an embodiment, the programmable user interface 160 is configured to receive the input indicative of the selected customized feedback option from the array 162. For example, the tactile feedback 168 may be customized based on a selection of a low intensity tactile feedback or a high intensity tactile feedback. Further, the audio feedback 170 may be customized based on a selection of the ringtone feedback or the voice message feedback. Further, the audio feedback 170 may be customized by adjusting volume, pitch, and frequency, associated with the audio feedback 170. Furthermore, the visual feedback 172 may be customized based on a selection of a bar chart, a pie chart or an animation of the machine 100.

Further, at step 406, a feedback associated with the operational state of the machine 100 is provided on the display device 166 and the operator input devices 138, based on the selected customized feedback option. For example, the tactile feedback 168 may be provided on the operator input devices 138, the audio feedback 170 may be provided on the audio devices 164 and the visual feedback 172 on the display device 166. In one embodiment, the feedback may be associated with the implement system 102 of the machine 100. In one embodiment, the feedback may be provided using the programmable user interface 160 by communicating with the machine ECM 142 For example, the feedback may be based on the feedback signals received from the sensors 154, 156 and 158 configured to monitor the pressure of fluid that is applied to the actuators 118, 124, and 128 using the control valves 148, 150 and 152 to control the operational state of the implement system 102 and the machine 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An operator station for a machine, the operator station comprising:
a display device;
an operator input device; and
a programmable user interface configured to:
provide an array of feedback options;
receive an input indicative of a selected customized feedback option from the array of feedback options; and
provide a feedback associated with an operational state of the machine on at least one of the display device and the operator input device based on the selected customized feedback option.

2. The operator station of claim 1, wherein the programmable user interface is configured to operatively communicate with a machine engine control module to provide the feedback associated with the operational state of the machine on the display device and the operator input device.

3. The operator station of claim 1, wherein the array of feedback options includes a tactile feedback configured to be provided on the operator input device, the tactile feedback is customized based on a selection of at least one of a low intensity tactile feedback and a high intensity tactile feedback using the programmable user interface.

4. The operator station of claim 1, wherein the array of feedback options includes an audio feedback configured to be provided on an audio device, the audio feedback is customized using the programmable user interface based on a selection of at least one of:
a ringtone feedback;
a voice message feedback; and
an adjustable volume, pitch and frequency associated with the audio feedback.

5. The operator station of claim 1, wherein the array of feedback options includes a visual feedback configured to be provided on the display device, the visual feedback is customized based on a selection of at least one of a bar chart, a pie chart and an animation of the machine using the programmable user interface.

6. The operator station of claim 1, wherein the programmable user interface is further configured to store the selected customized feedback option.

7. A programmable user interface within an operator station of a machine, the programmable user interface configured to:
provide an array of feedback options;
receive an input indicative of a selected customized feedback option from the array of feedback options; and
provide a feedback associated with an operational state of the machine on at least one of a display device and an operator input device based on the selected customized feedback option.

8. The programmable user interface of claim 7 is further configured to operatively communicate with a machine engine control module to provide the feedback associated with the operational state of the machine on the display device and the operator input device.

9. The programmable user interface of claim 7 is further configured to provide at least one of a tactile feedback on the operator input device, an audio feedback on an audio device and a visual feedback on the display device

10. The programmable user interface of claim 9, wherein the tactile feedback is configured to be customized based on a selection of at least one of a low intensity tactile feedback and a high intensity tactile feedback.

11. The programmable user interface of claim 9, wherein the audio feedback is configured to be customized based on a selection of at least one of:
a ringtone feedback;
a voice message feedback; and
an adjustable volume, pitch and frequency associated with the audio feedback.

12. The programmable user interface of claim 9, wherein the visual feedback is configured to be customized based on a selection of at least one of a bar chart, a pie chart and an animation of the machine.

13. The programmable user interface of claim 7 is further configured to store the selected customized feedback option.

14. A method for providing a feedback associated with an operational state of a machine, the method comprising:
providing an array of feedback options using a programmable user interface;
receiving an input indicative of a selected customized feedback option from the array of feedback options; and
providing the feedback associated with the operational state of the machine on at least one of a display device and an operator input device based on the selected customized feedback option.

15. The method of claim 14 further comprises communicating with a machine engine control module to provide the feedback associated with the operational state of the machine on the display device and the operator input device.

16. The method of claim 14, wherein providing the feedback further comprises providing at least one of a tactile feedback on the operator input device, an audio feedback on an audio device and a visual feedback on the display device.

17. The method of claim 14, wherein receiving the input further comprises customizing a tactile feedback based on a selection of at least one of a low intensity tactile feedback and a high intensity tactile feedback.

18. The method of claim 14 wherein receiving the input further comprises:
customizing an audio feedback based on a selection of at least one of a ringtone feedback and a voice message feedback: and
adjusting at least one of volume, pitch and frequency associated with the audio feedback.

19. The method of claim 14 wherein receiving the input further comprises customizing a visual feedback based on a selection of at least one of a bar chart, a pie chart and an animation of the machine.

20. The method of claim 14 further comprises storing the selected customized feedback option.
